(19) United States
(12) Patent Application Publication
(10) Pub. No.: US 2023/0188317 A1
(43) Pub. Date: Jun. 15, 2023

(54) APPARATUS AND METHOD WITH HOMOMORPHIC ENCRYPTION

(71) Applicants: Samsung Electronics Co., Ltd., Suwon-si (KR); Seoul National University R&DB Foundation, Seoul (KR); Industry Academic Cooperation Foundation, Chosun University, Gwangju (KR); Daegu Gyeongbuk Institute of Science and Technology, Daegu (KR)

(72) Inventors: Woosuk CHOI, Suwon-si (KR); Joon-Woo LEE, Seoul (KR); Eunsang LEE, Seoul (KR); Young-Sik KIM, Gwangju (KR); Yongjune KIM, Daegu (KR); Jong-Seon NO, Seoul (KR); Junghyun LEE, Seoul (KR)

(73) Assignees: Samsung Electronics Co., Ltd., Suwon-si (KR); Seoul National University R&DB Foundation, Seoul (KR); Industry Academic Cooperation Foundation, Chosun University, Gwangju (KR); Daegu Gyeongbuk Institute of Science and Technology, Daegu (KR)

(21) Appl. No.: 17/888,836

(22) Filed: Aug. 16, 2022

(30) Foreign Application Priority Data
Dec. 9, 2021 (KR) 10-2021-0176040
Apr. 5, 2022 (KR) 10-2022-0042400

(51) Int. Cl. H04L 9/00

(52) U.S. Cl. CPC H04L 9/008; H04L 9/006

(57) ABSTRACT

An apparatus includes: one or more processors configured to: generate packed data by performing data packing on an encrypted image; and perform a homomorphic encryption operation based on the packed data and a weight.

### CROSS-REFERENCE TO RELATED APPLICATIONS

This application claims the benefit under 35 USC § 119(a) of Korean Patent Application No. 10-2021-0176040 filed on Dec. 9, 2021, and Korean Patent Application No. 10-2022-0042400 filed on Apr. 5, 2022, in the Korean Intellectual Property Office, the entire disclosures of which are incorporated herein by reference for all purposes.

### BACKGROUND

### 1. Field

The following description relates to an apparatus and method with homomorphic encryption.

### 2. Description of Related Art

Homomorphic encryption is a promising encryption method that may enable arbitrary operations between encrypted data. Utilizing homomorphic encryption may enable performing arbitrary operations on encrypted data without decrypting the encrypted data, and homomorphic encryption may be lattice-based and thus, resistant to quantum algorithms and safe.

In order to reduce overall operation time in an approximate homomorphic encryption, as much data as possible may be packed in one ciphertext and the operation may be performed at once. When convolution is performed with a stride greater than “1” in a scheme, the density of valid data in an output ciphertext may be reduced by the square of the stride.

For example, when convolution is performed with a stride of “2”, the density of valid data may be reduced by 4 times, such that when an operation is performed after convolution, computational efficiency may decrease by 4 times.

When a convolution with a stride of “2” is performed multiple times, the computational efficiency may continuously decrease by, for example, 16 times and 64 times.

### SUMMARY

This Summary is provided to introduce a selection of concepts in a simplified form that are further described below in the Detailed Description. This Summary is not intended to identify key features or essential features of the claimed subject matter, and is not intended to be used as an aid in determining the scope of the claimed subject matter.

In one general aspect, an apparatus includes: one or more processors configured to: generate packed data by performing data packing on an encrypted image; and perform a homomorphic encryption operation based on the packed data and a weight.

The apparatus may include a receiver configured to receive the encrypted image and the weight, the encrypted image being for performing the homomorphic encryption operation and the weight being for performing an operation with the encrypted image.

The encrypted image may be generated by encoding an input image into a one-dimensional vector and encrypting the encoded one-dimensional vector.

The weight may be encoded as a one-dimensional vector.

For the generating of the packed data, the one or more processors may be configured to: determine a mapping constant based on a dimension of a tensor corresponding to the encrypted image; and generate the packed data by mapping data comprised in the encrypted image to an extended tensor based on the mapping constant.

The one or more processors may be configured to determine the mapping constant based on a number of channels in the tensor corresponding to the encrypted image and a predetermined interval.

For the generating of the packed data, the one or more processors may be configured to: determine a mapping constant based on a dimension of a tensor corresponding to the encrypted image; obtain a mapped tensor by mapping data comprised in the encrypted image to an extended tensor based on the mapping constant; and generate the packed data based on a combination of the mapped tensor.

For the generating of the packed data based on the combination of the mapped tensor, the one or more processors may be configured to: generate copied tensors by copying the mapped tensor a plurality of times; and generate the packed data by arranging the copied tensors in an order.

For the performing of the homomorphic encryption operation, the one or more processors may be configured to: perform a convolution operation based on the packed data and the weight; perform a rotation operation and addition on a result of the convolution operation; and generate a homomorphic encryption operation result by extracting a valid value from a result of the rotation operation and the addition.

The generating of the homomorphic encryption operation result, the one or more processors may be configured to generate the homomorphic encryption operation result by multiplying the valid value among the result of the rotation operation and the addition by “0” and multiplying a remaining value among the result of the rotation operation and the addition by “1”.

The homomorphic encryption operation result may be configured in a form in which a plurality of ciphertexts corresponding to a same plain text are repeated.

In another general aspect, a processor-implemented method includes: generating packed data by performing data packing on an encrypted image; and performing a homomorphic encryption operation based on the packed data and a weight.

The method may include receiving the encrypted image and the weight, the encrypted image being for performing the homomorphic encryption operation and the weight being for performing an operation with the encrypted image.

The encrypted image may be generated by encoding an input image into a one-dimensional vector and encrypting the encoded one-dimensional vector.

The weight may be encoded as a one-dimensional vector.

The generating of the packed data may include: determining a mapping constant based on a dimension of a tensor corresponding to the encrypted image; and generating the packed data by mapping data comprised in the encrypted image to an extended tensor based on the mapping constant.

The determining of the mapping constant may include determining the mapping constant based on a number of channels in the tensor corresponding to the encrypted image and a predetermined interval.

The generating of the packed data may include: determining a mapping constant based on a dimension of a tensor corresponding to the encrypted image; obtaining a mapped tensor by mapping data comprised in the encrypted image to an extended tensor based on the mapping constant; and generating the packed data based on a combination of the mapped tensor.

The generating of the packed data based on the combination of the mapped tensor may include: generating copied tensors by copying the mapped tensor a plurality of times; and generating the packed data by arranging the copied tensors in an order.

The performing of the homomorphic encryption operation may include: performing a convolution operation based on the packed data and the weight; performing a rotation operation and addition on a result of the convolution operation; and generating a homomorphic encryption operation result by extracting a valid value from a result of the rotation operation and the addition.

The generating of the homomorphic encryption operation result may include generating the homomorphic encryption operation result by multiplying the valid value among the result of the rotation operation and the addition by “0” and multiplying a remaining value among the result of the rotation operation and the addition by “1”.

The homomorphic encryption operation result may be configured in a form in which a plurality of ciphertexts corresponding to a same plain text are repeated.

In another general aspect, one or more embodiments include a non-transitory computer-readable storage medium storing instructions that, when executed by one or more processors, configure the one or more processors to perform any one, any combination, or all operations and methods described herein.

In another general aspect, a processor-implemented method includes: determining a mapping constant based on a dimension of a tensor corresponding to an image; generating packed data by mapping data comprised in the image to an extended tensor based on the mapping constant; and performing a convolution operation based on the packed data and a weight.

The method may include performing a homomorphic encryption operation comprising the convolution operation, wherein the image is an encrypted image.

Other features and aspects will be apparent from the following detailed description, the drawings, and the claims.

### BRIEF DESCRIPTION OF THE DRAWINGS

FIG. 1 illustrates an example of a homomorphic encryption operation apparatus.

FIG. 2 illustrates an example of an operation of a homomorphic encryption operation apparatus of FIG. 1.

FIG. 3 illustrates an example of data packing.

FIGS. 4A to 4C illustrate an example of data packing.

FIGS. 5A and 5B illustrate an example of an algorithm corresponding to a data packing scheme.

FIG. 6A illustrates an example of data packing.

FIG. 6B illustrates an example of a convolution operation using packing.

FIG. 7 illustrates an example of an algorithm corresponding to a data packing scheme.

FIG. 8 illustrates a process of mapping a three-dimensional vector to a one-dimensional vector.

FIG. 9 illustrates an example of an operation of a homomorphic encryption operation apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The terminology used herein is for the purpose of describing particular examples only and is not limit the examples. The singular forms “a”, “an”, and “the” are intended to include the plural forms as well, unless the context clearly indicates otherwise. The term “and/or” includes any one and any combination of any two or more of the associated listed items. It will be further understood that the terms “comprises/comprising” and/or “includes/including” when used herein, specify the presence of stated features, integers, steps, operations, elements, components, and/or combinations thereof, but do not preclude the presence or addition of one or more other features, integers, steps, operations, elements, components and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms including technical and scientific terms used herein have the same meaning as commonly understood by one of ordinary skill in the art to which this disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein.

When describing the examples with reference to the accompanying drawings, like reference numerals refer to like constituent elements and a repeated description related thereto will be omitted. In the description of the examples, a detailed description of well-known related structures or functions will be omitted when it is deemed that such description will cause ambiguous interpretation of the present disclosure.

Although terms, such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

The same name may be used to describe an element included in the examples described above and an element having a common function. Unless otherwise mentioned, the descriptions of the examples may be applicable to the following examples and thus, duplicated descriptions will be omitted for conciseness.

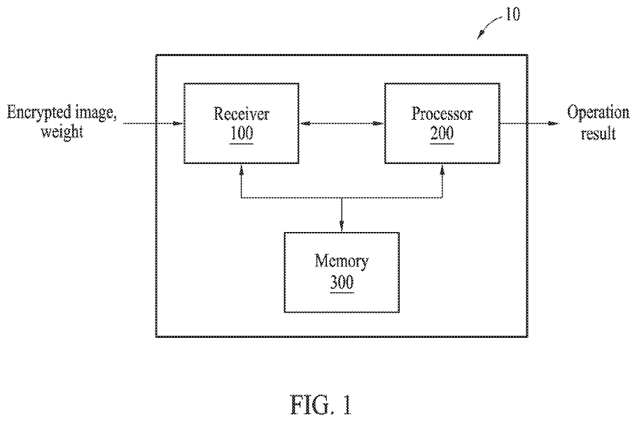

FIG. 1 illustrates an example of a homomorphic encryption operation apparatus.

Referring to FIG. 1, a homomorphic encryption operation apparatus 10 may perform a homomorphic encryption operation. The homomorphic encryption operation may be performed using a neural network. The homomorphic encryption operation may include a convolution operation, a down sampling operation, and/or an average pooling operation. The homomorphic encryption operation apparatus 10 of one or more embodiments may perform the convolution with a stride greater than “1” while maintaining computational efficiency.

Homomorphic encryption may be an encryption scheme configured to perform various operations on data that is encrypted. In homomorphic encryption, a result of an operation using ciphertexts may become a new ciphertext, and a plaintext obtained by decrypting the ciphertext may be the same as the operation result of the original data before encryption.

Hereinafter, encrypted data and/or encrypted text may be referred to as a ciphertext.

The neural network may generally refer to a model having a problem-solving ability implemented through nodes forming a network through connections where a strength of the connections is changed through learning.

A node of the neural network may include a combination of weights or biases. The neural network may include one or more layers, each including one or more nodes. The neural network may infer a result from a predetermined input by changing the weights of the nodes through training.

The neural network may include a deep neural network (DNN). The neural network may include a convolutional neural network (CNN), a recurrent neural network (RNN), a perceptron, a multiplayer perceptron, a feed forward (FF), a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and/or an attention network (AN).

The homomorphic encryption operation apparatus 10 may be, or be implemented in, a personal computer (PC), a data server, or a portable device.

The portable device may be or include, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal or portable navigation device (PND), a handheld game console, an e-book, a smart device, and/or the like. The smart device may include, for example, a smart watch, a smart band, and/or a smart ring.

The homomorphic encryption operation apparatus 10 may include a receiver 100 and a processor 200 (e.g., one or more processors). The homomorphic encryption operation apparatus 10 may further include a memory 300 (e.g., one or more memories).

The receiver 100 may include a receiving interface. The receiver 100 may receive data for a homomorphic encryption operation. The receiver 100 may receive an encrypted image for performing the homomorphic encryption operation and a weight for performing an operation with the encrypted image. The receiver 100 may output the received encrypted image and the weight to the processor 200.

The processor 200 may process data stored in the memory 300. The processor 200 may execute computer-readable code (e.g., software) stored in the memory 300 and instructions triggered by the processor 200.

The processor 200 may be a data processing device including hardware including a circuit having a physical structure to perform desired operations. For example, the desired operations may include code or instructions included in a program.

For example, the hardware-implemented data processing device may include a microprocessor, a central processing unit (CPU), a processor core, a multi-core processor, a multiprocessor, an application-specific integrated circuit (ASIC), and/or a field-programmable gate array (FPGA).

The processor 200 may generate packed data by performing data packing on an encrypted image. The encrypted image may be generated by encoding an input image into a one-dimensional vector and encrypting the encoded one-dimensional vector. A weight may be encoded as a one-dimensional vector.

The processor 200 may perform a rotation operation on the input image or the encrypted image. The processor 200 may multiply data included in the encrypted image by a predetermined constant value. For example, the predetermined constant may be “1”. The processor 200 may generate packed data by multiplying remaining data among data included in the encrypted image by “0”.

The processor 200 may determine a mapping constant based on a dimension of a tensor corresponding to the encrypted image. The tensor may be a space of an arbitrary size in which data is stored. The dimension of the tensor may include a height, a width, and a number of channels of the tensor.

The processor 200 may determine the mapping constant based on the number of channels in the tensor corresponding to the encrypted image and a predetermined interval.

The processor 200 may generate packed data by mapping data included in the encrypted image to an extended tensor based on the mapping constant.

The processor 200 may determine a mapping constant based on a dimension of a tensor corresponding to the encrypted image. The processor 200 may obtain a mapped tensor by mapping data included in the encrypted image to the extended tensor based on the mapping constant. The processor 200 may generate the packed data based on a combination of the mapped tensor.

The processor 200 may generate the packed data by determining the mapping constant based on the width, height, or number of channels of the mapped tensor.

The processor 200 may generate copied tensors by copying the mapped tensors a plurality of times. The processor 200 may generate the packed data by arranging the copied tensors in order.

The processor 200 may perform a homomorphic encryption operation based on the packed data and a weight.

The processor 200 may perform a convolution operation based on the packed data and the weight. The processor 200 may perform a rotation operation and addition on a result of the convolution operation. The processor 200 may generate a homomorphic encryption operation result by extracting a valid value from a result of the rotation operation and the addition. The homomorphic encryption operation result may be configured in a form in which a plurality of ciphertexts corresponding to the same plaintext are repeated. The plurality of ciphertexts may be randomly encrypted and have different shapes.

The processor 200 may generate the homomorphic encryption operation result by multiplying a valid value among the result of the rotation operation and the addition by “0” and multiplying a remaining value among the result of the rotation operation and the addition by “1”. The valid value may be data used for a subsequent operation. The processor 200 may determine a mapping constant based on a dimension of a tensor corresponding to the encrypted image. The processor 200 may obtain a mapped tensor by mapping data included in a rotated image to the extended tensor based on the mapping constant.

The processor 200 may generate an addition result by performing addition on data included in the mapped tensor. The processor 200 may generate a multiplication result by multiplying the addition result by a constant determined based on the dimension of the tensor of the encrypted image.

The processor 200 may generate an average pooling output result by extracting valid data from the multiplication result based on a predetermined interval and arranging the valid data in a one-dimensional vector.

The memory 300 may be implemented as a volatile memory device and/or a non-volatile memory device.

The volatile memory device may be implemented as a dynamic random-access memory (DRAM), a static random-access memory (SRAM), a thyristor RAM (T-RAM), a zero capacitor RAM (Z-RAM), and/or a twin transistor RAM (TTRAM).

The non-volatile memory device may be implemented as an electrically erasable programmable read-only memory (EEPROM), a flash memory, a magnetic RAM (MRAM), a spin-transfer torque-MRAM (STT-MRAM), a conductive bridging RAM (CBRAM), a ferroelectric RAM (FeRAM), a phase change RAM (PRAM), a resistive RAM (RRAM), a nanotube RRAM, a polymer RAM (PoRAM), a nano-floating gate memory (NFGM), a holographic memory, a molecular electronic memory device, and/or an insulator resistance change memory.

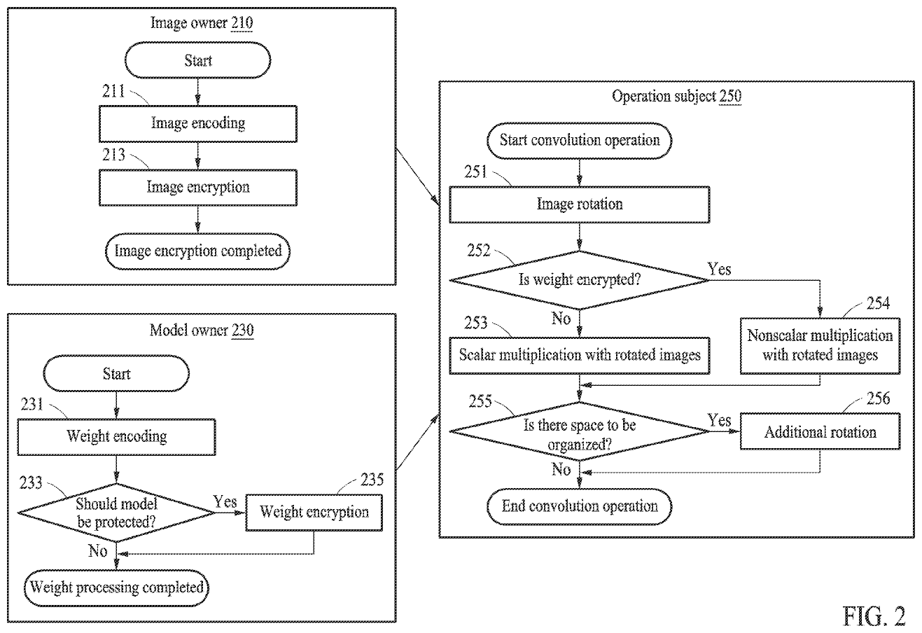

FIG. 2 illustrates an example of an operation of a homomorphic encryption operation apparatus (e.g., the homomorphic encryption operation apparatus of FIG. 1).

Referring to FIG. 2, a processor (e.g., the processor 200 of FIG. 1) may include an image owner 210, a model owner 230, and an operation subject 250. The image owner 210, the model owner 230, and the operation subject 250 may be, or be implemented on, one piece of hardware (e.g., a same processor) or may be, or be implemented on, different pieces of hardware (e.g., a plurality of processor).

The image owner 210 may generate an operation target of the homomorphic encryption operation and output the operation target to the operation subject 250. The image owner 210 may generate an encrypted image and output the encrypted image to the operation subject 250. The image owner 210 may perform image encoding 211. The image encoding 211 may be a process of converting an encrypted image into a one-dimensional vector.

The image owner 210 may perform image encryption 213. For example, the image owner 210 may map a [symbol] ^{N/2} vector to a R= [symbol] [X]/(X^{N}+1) ring element, and the image owner 210 may encrypt the R= [symbol] [X]/(X^{N}+1) element into an actual ciphertext ct∈R_{Q}_{_{L}}² (R_{Q}_{_{L}}= [symbol] _{Q}_{_{L}}[X]/(X^{N}+1). Through the encryption, the image owner 210 may make it impossible for a person who does not possess a secret key to know the corresponding plaintext data or information about the encoded R element through the ciphertext.

The model owner 230 may generate a weight for the homomorphic encryption operation and output the weight to the operation subject 250. The model owner 230 may perform weight encoding 231. The model owner 230 may determine whether a model is to be protected 233. When the model owner 230 determines that the model is to be protected, encryption of the weight may be performed 235.

The operation subject 250 may perform the homomorphic encryption operation based on the encrypted image and the weight (or, an encrypted weight). The example of FIG. 2 may be a case in which a convolution operation is performed.

The operation subject 250 may perform rotation of the encrypted image 251. The operation subject 250 may determine whether the weight is encrypted 252. When the operation subject 250 determines the weight is not encrypted, the operation subject 250 may perform scalar multiplication with the rotated images 253. When the operation subject 250 determines the weight is encrypted, the operation subject 250 may perform a nonscalar multiplication with the rotated images 254.

The operation subject 250 may determine whether a space for the rotated image is to be organized 255. When the operation subject 250 determines the space for the rotated image is to be organized, the operation subject 250 may perform additional rotation 256. When the operation subject 250 determines the space for the rotated image is not to be organized, the output of 255 may be determined as the operation result.

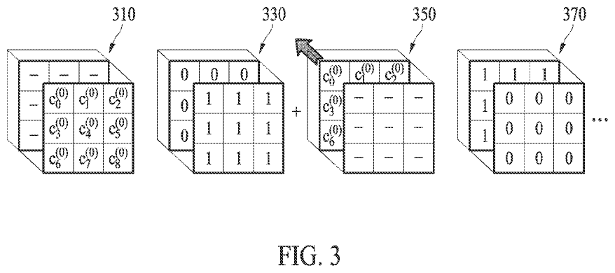

FIG. 3 illustrates an example of data packing.

Referring to FIG. 3, a processor (e.g., the processor 200 of FIG. 1) may generate packed data by performing data packing on a rotated image based on a rotated weight.

The processor 200 may multiply valid data among the rotated data by a predetermined constant value. For example, the predetermined constant may be “1”. The processor 200 may generate packed data by multiplying remaining data (e.g., data excluding the valid data) among the rotated data by “0”.

When a convolution operation is performed, the processor 200 may perform a task of multiplying a weight for each channel and adding data through rotation. In this case, valid data packing density for one ciphertext may be low.

The processor 200 may collect results obtained by multiplying the weights for each channel and adding the weights in one ciphertext so that the data packing density used for an operation does not decrease. The example of FIG. 3 may be a process of selecting only valid data from among the results for each channel and collecting the valid data into one ciphertext.

The processor 200 may pack only valid data by multiplying a rotated image 310 by a weight 330, and may pack the only valid data by multiplying a rotated image 350 by a weight 370.

The processor 200 may remove meaningless data to extract only valid data by multiplying the valid data by a predetermined constant (e.g., “1” or an arbitrary constant value) and multiplying the meaningless data (e.g., the remaining data) by “0”. An output tensor obtained by adding all of the extracted valid data may be used to efficiently perform a homomorphic encryption operation since the data is densely packed.

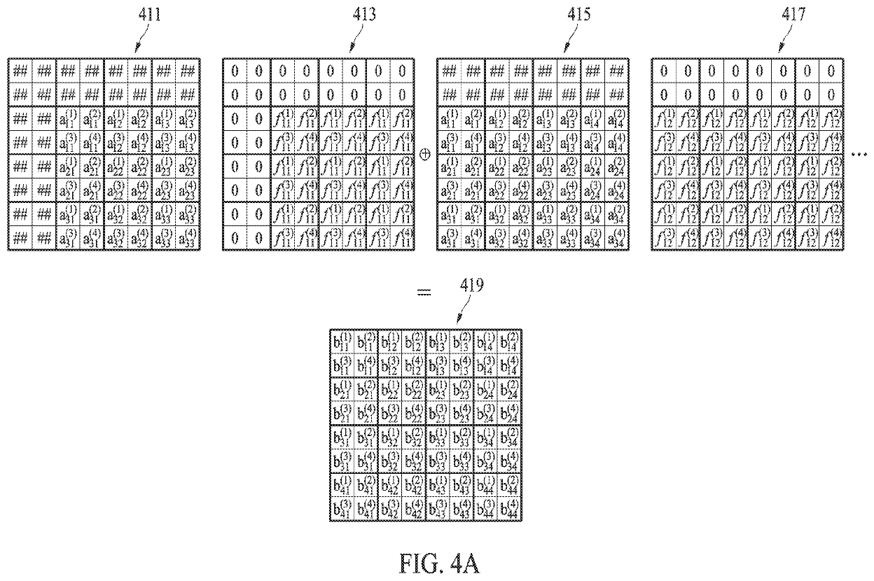

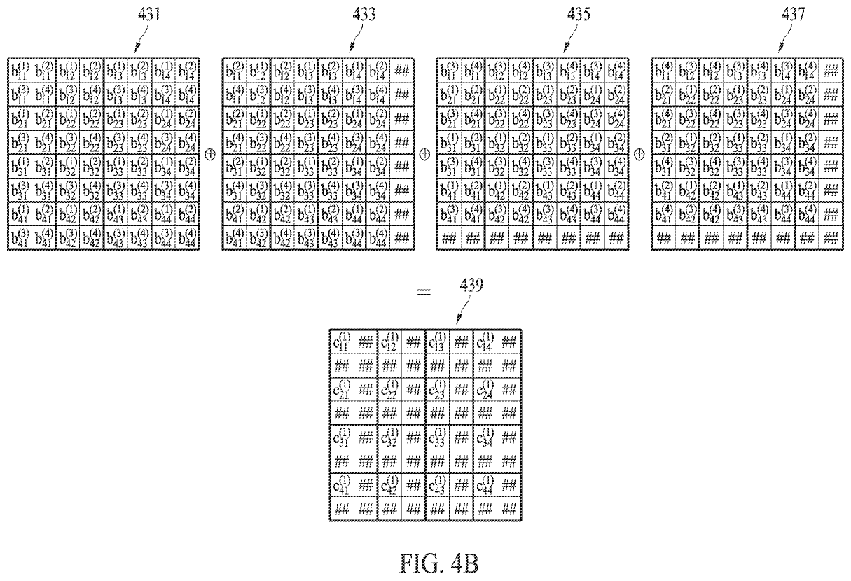

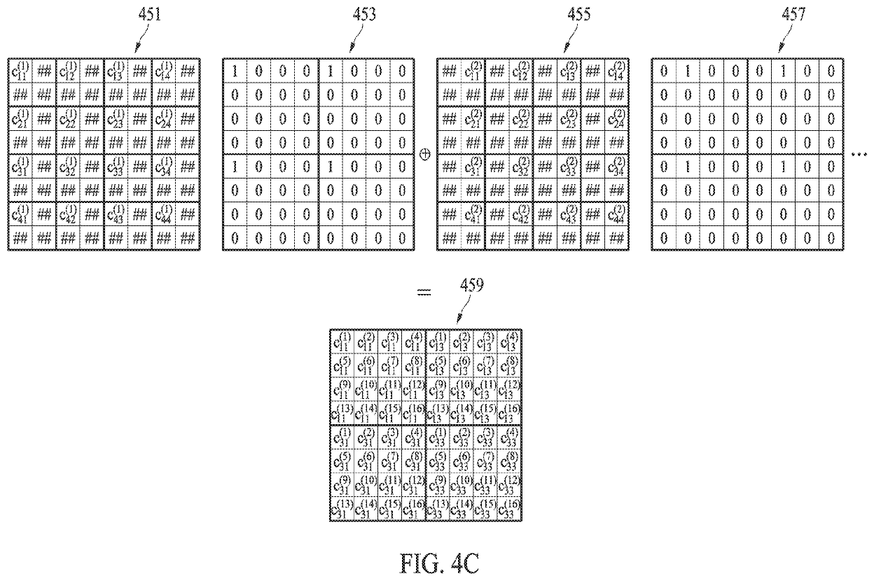

FIGS. 4A to 4C illustrate an example of data packing.

Referring to FIGS. 4A to 4C, a processor (e.g., the processor 200 of FIG. 1) may determine a mapping constant based on a dimension of a tensor corresponding to an encrypted image. The processor 200 may determine the mapping constant based on the number of channels in the tensor corresponding to the encrypted image and a predetermined interval.

The processor 200 may generate packed data by mapping data included in a rotated image to an extended tensor based on the mapping constant.

The processor 200 may effectively perform a convolution operation (e.g., a multiplexed convolution operation) having a stride of “2” or more through data packing.

The processor 200 may perform a task of collecting valid data at the end of the convolution operation. The processor 200 may collect the valid data such that a gap (or interval) kₒ becomes s times a gap kᵢ of input data. The processor 200 may collect the data using one kₒ such that kₒ=skᵢ. This may allow the processor 200 to prevent an empty space from forming in a ciphertext as the data interval increases, and efficiently perform a homomorphic encryption operation (e.g., convolution or bootstrapping) by compactly collecting data, when the stride is “2” or more.

When an input tensor is A∈ [symbol] × [symbol] × [symbol] ^{c}, and with respect to a predetermined interval k,

$$t = ⌈ \frac{c}{{k}^{2}} ⌉ ,$$

the processor 200 may map the input tensor which is A∈ [symbol] × [symbol] × [symbol] ^{c} using the predetermined interval k to a A′∈ [symbol] × [symbol] × [symbol] ^{t} tensor using Equation 1 below, for example. Here, a mapping constant may include k or t.

$${A}_{{j}_{5} , {j}_{6} , {j}_{7}}^{′} = \{ \begin{matrix}{A}_{⌊ {j}_{5} / k ⌋ , ⌊ {j}_{6} / k ⌋ , {k}^{3} {i}_{7} + k ( {j}_{5} modk ) + {j}_{6} modk} , \\ if {k}^{2} {i}_{7} + k ⌊ {j}_{5} / k ⌋ + ⌊ {j}_{6} / k ⌋ < e \\ 0 , otherwise\end{matrix} , \\ for 0 \leq {j}_{5} < k ℓ , 0 \leq {j}_{6} < k ℓ , 0 \leq {i}_{7} < t . \qquad Equation 1$$

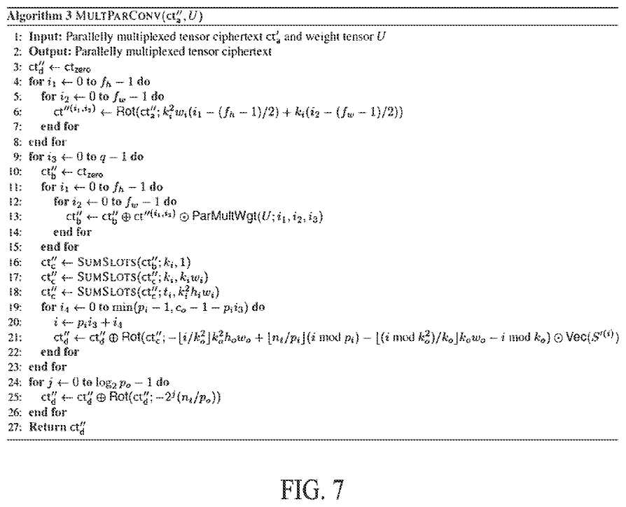

The processor 200 may map the mapped A′ tensor to a one-dimensional vector on [symbol] ⁿ by applying the Vec function. A non-limiting example of the Vec function will be described in detail with reference to FIG. 7.

The processor 200 may perform a rotation operation on the input tensor and a weight, respectively. The processor 200 may perform a rotation operation as much as k for the predetermined interval (e.g., k).

The processor 200 may perform a process of multiplying the rotated tensor and the rotated weight, and adding the multiplication result to all input channels. The processor 200 may perform at least one rotation among rotation from the front page to the back page, up/down rotation, or left/right rotation, and may add the rotated values.

A result of performing addition on the input channels after multiplying the weights may be a tensor having a low data packing density with only partially valid data. The processor 200 may extract only valid data by multiplying each output channel of the tensor having the low data packing density by the weights and collect the valid data into one ciphertext.

The processor 200 may extract only valid data by multiplying the only valid data by “1” (or, an arbitrary constant value other than “0”) and multiplying meaningless data by “0”. The processor 200 may generate a packed output tensor by adding the results for each output channel. Since a final generated output tensor is a result of packing, the data packing density may be high. The processor 200 may efficiently perform a homomorphic encryption operation using data having a high packing density.

When a convolution operation is performed, the processor 200 may prevent the data packing density from falling even when the stride is set to a value greater than “1”. The processor 200 may maintain the packing density by packing data of the input tensor at a predetermined interval, and packing data for a plurality of input channels into one rectangle.

The processor 200 may perform a homomorphic convolution in which an output ciphertext having a multiplexed output tensor is output for an input ciphertext having a multiplexed input tensor. The processor 200 may perform a convolution operation (e.g., a single-input single-output (S ISO) operation), and add convolution results for all input channels, and select and collect only valid values to multiplexed form.

The processor 200 may perform a convolution (S≥2) having a stride of “2” or more. S may be a stride of a convolution. The processor 200 may select a valid value and collect the valid value for an output gap kₒ=skᵢ instead of an input gap kᵢ. Here, the gap may be an interval between the valid data.

The output ciphertext may include a stride convolution result in the form of a multiplexed tensor with respect to kₒ=skᵢ. Hereinafter, a convolution using multiplexed packing as described above is referred to as a multiplexed convolution, and is denoted as MultConv.

The processor 200 may generate a rotated image 411 and a rotated image 415 by performing a rotation operation on an encrypted image. Similarly, the processor 200 may generate a rotated weight 413 and a rotated weight 417. The processor 200 may generate an operation result 419 based on the rotated images 411 and 415 and the rotated weights 413 and 417.

The processor 200 may perform a rotation operation and addition. The processor 200 may generate images 431, 433, 435, and 437 by performing a rotation operation on the operation result 419. The processor 200 may generate an operation result 439 by adding the images 431, 433, 435, and 437.

The processor 200 may perform data packing by extracting only valid data from the operation result 439. The processor 200 may extract packed data 459 by extracting only the valid data using an operation result 451 and an operation result 455, and a weight 453 and a weight 457.

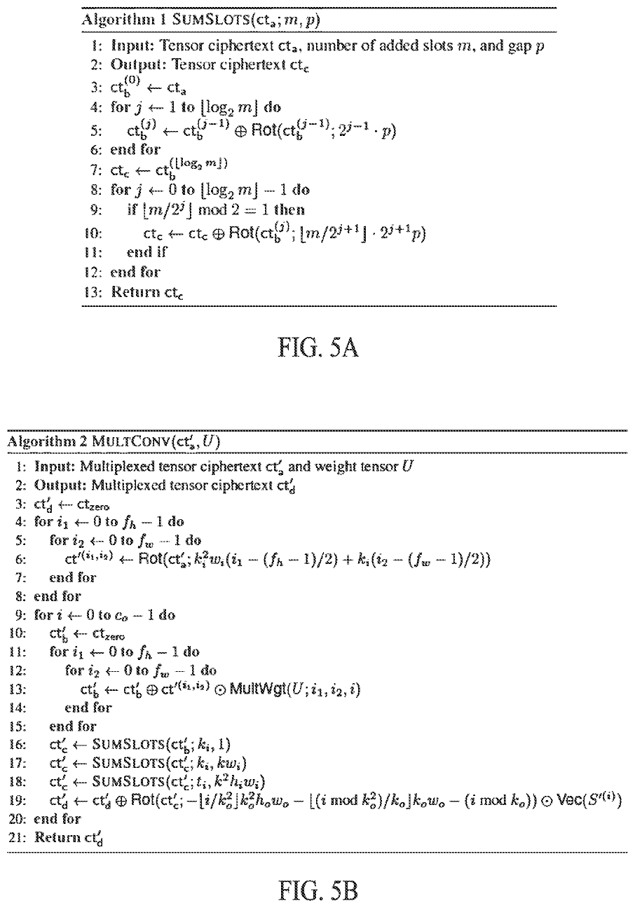

FIGS. 5A and 5B illustrate an example of an algorithm corresponding to a data packing scheme (e.g., the data packing scheme of FIGS. 4A to 4C).

Referring to FIGS. 5A and 5B, with respect to a vector x=(x₀, x₁, . . . , xₙ₋₁), [symbol] x [symbol] ᵣ may be a vector in which the vector x is cyclically shifted to the left by r. In other words, [symbol] x [symbol] ᵣ=(xᵣ, xᵣ₊₁, . . . , xₙ₋₁, x₀, . . . , xᵣ₋₁).

In an example encryption scheme of a homomorphic encryption algorithm (e.g., RNS-CKKS), the form of a ciphertext may be (b, a)∈ [symbol] . [symbol] = [symbol] qᵢ may be a product of prime numbers, and may be

$${R}_{{Q}_{ℓ}} = {ℤ}_{{Q}_{ℓ}} [ X ] / ( {X}^{N} + 1 ) . \frac{N}{2}$$

real (or complex) values may be encrypted in

$$\frac{N}{2}$$

slots in one ciphertext. The total number of slots

$$\frac{N}{2}$$

in the ciphertext may be expressed as nₜ. Hereinafter, an encryption process is denoted by Enc, and a decryption process is denoted by Dec. ct, ct₁, ct₂, ct₃, ct′ may be a ciphertext, and u, v, v₁, v₂ may be a vector on [symbol] ⁿ^{ₜ}.

A processor (e.g., the processor 200 of FIG. 1) may perform homomorphic addition, homomorphic substitution, homomorphic multiplication, and a homomorphic rotation operations as follows:
Homomorphic addition and substitution (⊕, ⊖)
   ct⊕u (resp. ct⊖n)→ct′: If Dec(ct)=v, then Dec(ct′)=v+u(resp. v−u).
   ct₁⊕ct₂ (resp. ct₁⊖ct₂)→ct₃: If Dec(ct₁)=v₁ and Dec(ct₂)=v₂, then Dec(ct₃)=v₁+v₂ (resp. v₁−v₂).
Homomorphic multiplication (⊙, ⊗)
   ct⊙u→ct′: If Dec(ct)=v, then Dec(ct′)=v·u.
   ct₁⊗ct₂→ct₃: if Dec(ct₁)=v₁ and Dec(ct₂)=v₂, then Dec(ct₃)=v₁·v₂.
Homomorphic rotation (Rot)
   Rot(ct; r)→ct′: If Dec(ct)=v, then Dec(ct′)= [symbol] v [symbol] ᵣ.

An input of a convolution operation may be a three-dimensional tensor A∈ [symbol] ^{h}^{ᵢ}^{×w}^{ᵢ}^{×c}^{ᵢ}. hᵢ, wᵢ may denote the height and width of an input tensor, respectively. hₒ, wₒ may denote the height and width of an output tensor. A filter (or, a weight tensor) of the convolution operation may be U∈ [symbol] ^{f}^{ₕ}^{×f}^{_{w}}^{×c}^{ᵢ}^{×c}^{ₒ}. fₕ, f_{w} may denote the size of a kernel in the perpendicular and horizontal directions of the filter, respectively, and s may denote a stride of the convolution. kᵢ, kₒ may denote an interval or gap between data included in an input and output ciphertext, respectively, and tᵢ, tₒ may be

$${t}_{i} = ⌈ \frac{{c}_{i}}{{k}_{i}^{2}} ⌉ and {t}_{o} = ⌈ \frac{{c}_{o}}{{k}_{o}^{2}} ⌉ ,$$

respectively.

MultWgt(U; i₁, i₂, i) may be a function that maps a weight tensor U to an element of [symbol] ⁿ^{ₜ}. A three-dimensional multiplexed shifted weight tensor for a given i₁, i₂, i (0≤i₁<fₕ, 0≤i₂, f_{w}, 0≤i<cₒ) may defined as expressed in Equation 2 below, for example.

$${\overline{U}}_{{i}_{1} , {i}_{2} , {i}_{3}}^{′ ( {i}_{1} , {i}_{2} , i )} = \qquad Equation 2$$

$$\{ \begin{matrix}0 , & if {k}_{i}^{2} {i}_{5} + {k}_{i} ( {i}_{3} mod {k}_{i} ) + {i}_{4} mod {k}_{i} \geq {e}_{i} \\ & or ⌊ {i}_{3} / {k}_{i} ⌋ - ( {f}_{h} - 1 ) / 2 + {i}_{1} ∉ [ 0 , {h}_{i} - 1 ] \\ & or ⌊ {i}_{4} / {k}_{i} ⌋ - ( {f}_{w} - 1 ) / 2 + {i}_{2} ∉ [ 0 , {w}_{i} - 1 ] , \\ {U}_{i , {i}_{2} , {k}_{i}^{3} {i}_{5} + {k}_{i} ( {i}_{2} {modk}_{2} + {i}_{4} {modk}_{4} , i} , & otherwise\end{matrix} ,$$

$$for 0 \leq {i}_{3} < {k}_{i} {h}_{i} , 0 \leq {i}_{1} < {k}_{i} {w}_{i} , and 0 \leq {i}_{t} < {t}_{i} .$$

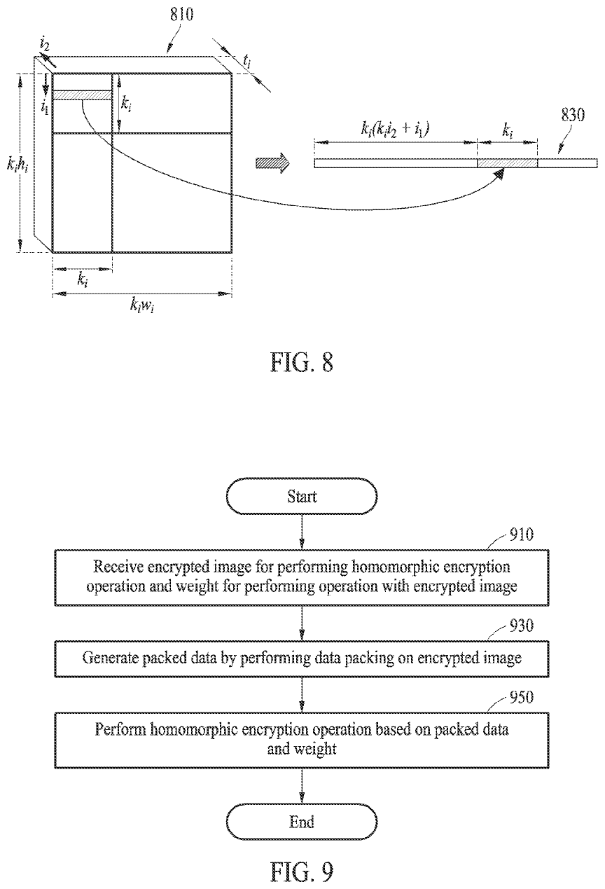

The MultWgt function may be defined as MultWgt(U; i₁, i₂, i)=Vec(Ū′⁽ⁱ^{₁}^{,i}^{₂}^{,i)}). A non-limiting example of the Vec function will be described in detail with reference to FIG. 8.

A multiplexed selecting tensor for S′^{(t)}=(S′ᵢ_{₃}_{,i}_{₄}_{,i}_{₅}^{(t)})_{0≤i}_{₃}_{<k}_{ₒ}ₕ_{ₒ}_{,0≤i}_{₄}_{<k}_{ₒ}_{w}_{ₒ}_{,0≤i}_{₅}_{<t}_{ₒ}∈ [symbol] ^{k}^{ₒ}^{h}^{ₒ}^{×k}^{ₒ}^{w}^{ₒ}^{×t}^{ₒ} for selecting a valid value in the MultConv algorithm may be defined as expressed in Equation 3 below, for example.

$${S}_{{i}_{3} , {i}_{4} , {i}_{5}}^{′ ( i )} = \{ \begin{matrix}1 , & if {k}_{o}^{2} {i}_{5} + {k}_{o} ( {i}_{3} mod {k}_{o} ) + {i}_{4} mod {k}_{o} = i \\ 0 , & otherwise\end{matrix} , \\ for 0 \leq {i}_{3} < {k}_{o} {h}_{o} , 0 \leq {i}_{4} < {k}_{o} {w}_{o} , and 0 \leq {i}_{5} < {t}_{o} . \qquad Equation 3$$

Sumslots of FIG. 5A may be an algorithm for adding m number of slot values spaced apart by p. The multiplexed convolution (MultConv) may be implemented as shown in FIG. 5B using the MultWgt function, a multiplexed selection tensor S′⁽ⁱ⁾, and a SumSlots algorithm. In FIG. 5B, ctzero may be a ciphertext of an all-zero vector 0∈ [symbol] ⁿ^{ₜ}.

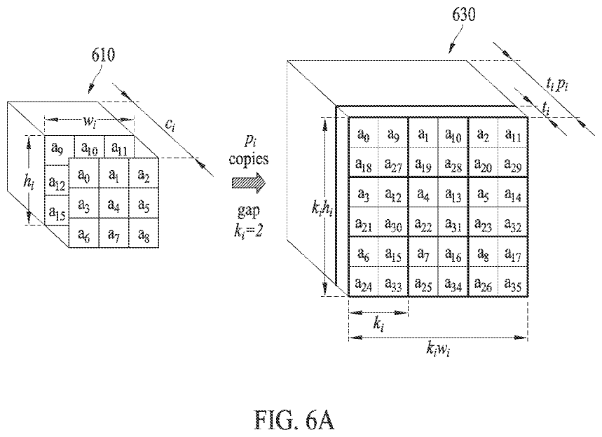

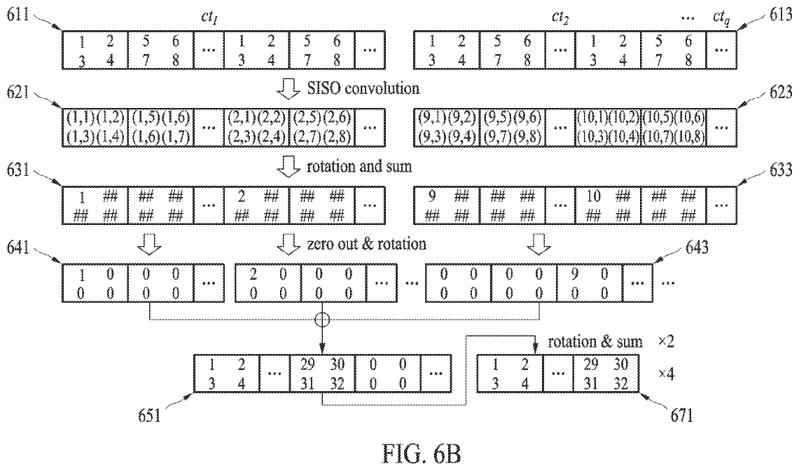

FIG. 6A illustrates an example of data packing, FIG. 6B illustrates an example of a convolution operation using packing (e.g., the packing of FIG. 6A), and FIG. 7 illustrates an example of an algorithm corresponding to a data packing method (e.g., the data packing method of FIG. 6).

Referring to FIGS. 6A to 7, a processor (e.g., the processor 200 of FIG. 1) may determine a mapping constant based on a dimension of a tensor corresponding to an encrypted image. The processor 200 may generate packed data by determining the mapping constant based on the width, height, or number of channels of the mapped tensor.

The processor 200 may obtain the mapped tensor by mapping data included in a rotated image to an extended tensor based on the mapping constant. The processor 200 may generate copied tensors by copying the mapped tensors a plurality of times. The processor 200 may generate the packed data by arranging the copied tensors in order in a one-dimensional vector.

The processor 200 may perform convolution on a packed input tensor. The processor 200 may simultaneously perform weight multiplication and rotation for a plurality of tensors by performing an operation on one ciphertext. Accordingly, the processor 200 may increase computational efficiency.

The processor 200 may simultaneously perform operations on several input tensors by packing the several input tensors in one ciphertext, thereby maximizing the efficiency of a convolution operation.

The processor 200 may obtain a stride-packed A′∈ [symbol] × [symbol] × [symbol] ^{t} for a predetermined interval k using the data packing scheme described with reference to FIGS. 5A and 5B of the input tensor 610 which is A∈ [symbol] × [symbol] × [symbol] ^{c}.

The processor 200 may list f copies of A′ in order. The processor 200 may map a plurality of tensors listed in order to a one-dimensional vector on [symbol] ⁿ using the Vec function. A copy of A′ may include “0” or meaningless data. When sparse slot bootstrapping can be used, the processor 200 may list f number of copies in the form of a sparse slot vector.

The processor 200 may use a greater number of slots than the data size to support bootstrapping and a precise, approximate rectified linear unit (ReLU) function. The processor 200 may perform a multiplexed parallel convolution operation that simultaneously performs SISO convolution on a plurality of output channels. Hereinafter, the multiplexed parallel convolution operation is expressed as MultParConv.

In the MultParConv, iteratively packed inputs may be considered as a plurality of independent inputs. The processor 200 may reduce convolution execution time of a multiplexed convolution operation (MultConv) by using the MultParConv. The example of FIG. 6B may be the MultParConv for kᵢ=2, cₒ=32.

The processor 200 may perform a convolution operation (e.g., an SISO convolution operation) based on packed data 611 and 613 and a received weight. The processor 200 may perform a rotation operation and addition on results 621 and 623 of the convolution operation.

The processor 200 may generate a homomorphic encryption operation result by extracting valid values from results 631 and 633 of the rotation operation and addition. The processor 200 may perform a zero out and a rotation operation on the results 631 and 633 of the rotation operation and the addition. The processor 200 may generate data 651 by collecting valid data among results 641 and 643 of the zero-out and the rotation operation, and may generate packed data 671 by performing a rotation operation and addition on the data 651.

Hereinafter, a process of the MultParConv is described in detail.

The processor 200 may pack pᵢ number of identical multiplexed tensors into one ciphertext by performing multiplexed parallel packing (MultParPack). The example of FIG. 6A may be a process of performing MultParPack on an input tensor which is 3×3×cᵢ with respect to a gap kᵢ=3 and pᵢ number of copies.

The multiplexed packing function (MultPack) may be a function that maps a tensor A∈ [symbol] ^{h}^{ᵢ}^{×w}^{ᵢ}^{×c}^{ᵢ} to a ciphertext Enc(Vec(A′)) for

$${t}_{i} = ⌈ \frac{{c}_{i}}{{k}_{i}^{2}} ⌉ .$$

In this case, A′∈ [symbol] ^{k}^{ᵢ}^{h}^{ᵢ}^{×k}^{ᵢ}^{w}^{ᵢ}^{×t}^{ᵢ} may be a multiplexed tensor that satisfies Equation 4 below, for example.

$${A}_{{i}_{3} , {i}_{4} , {i}_{5}}^{′} = \qquad Equation 4$$

$$\{ \begin{matrix}{A}_{⌊ {i}_{3} / {k}_{i} ⌋ , ⌊ {i}_{3} / {k}_{i} ⌋ , {k}_{i}^{2} {i}_{5} + {k}_{i} ( {i}_{3} {modk}_{i} ) + {i}_{3} {modk}_{i}} , & if {k}_{i}^{2} {i}_{5} + {k}_{i} ( {i}_{3} mod {k}_{i} ) + {i}_{4} mod {k}_{i} < {c}_{i} , \\ 0 , & otherwise\end{matrix} ,$$

$$for 0 \leq {i}_{3} < {k}_{i} {h}_{i} , 0 \leq {i}_{4} < {k}_{i} {w}_{i} , and 0 \leq {i}_{5} < {t}_{i} .$$

The processor 200 may obtain a multiplexed tensor A′∈ [symbol] ^{k}^{ᵢ}^{h}^{ᵢ}^{×k}^{ᵢ}^{w}^{ᵢ}^{×t}^{ᵢ} that satisfies the MultPack function MultPack(A)=Enc(Vec(A′) with respect to an input tensor A′∈ [symbol] ^{h}^{ᵢ}^{×w}^{ᵢ}^{×c}^{ᵢ}, and list pᵢ copies of the multiplexed tensor. An expanded tensor may be encrypted after being mapped to a [symbol] ⁿ^{ₜ} vector using the Vec function. The processor 200 may fill in a value of “0” between the copies if kₜ² hₜwₜtₜ is not divisible by nₜ.

The MultParPack function may be defined as expressed in Equation 5 below, for example.

$$MultParPack ( A ) = {⊕}_{j = 0}^{{p}_{i} - 1} Rot ( MultPack ( A ) ; j ( {n}_{i} / {p}_{i} ) ) \qquad Equation 5$$

While an entire convolution operation is being performed, a plaintext tensor and data included in a ciphertext slot may be equivalent in form to a multiplexed parallel packing form. The processor 200 may receive a parallelly multiplexed tensor for a gap kᵢ as an input and output a parallelly multiplexed tensor for an output gap kₒ by using the MultParConv algorithm.

When

$$q = ⌈ \frac{{c}_{o}}{{p}_{i}} ⌉ ,$$

the MultConv may have to perform rotation and addition process cₒ times, but since the MultParConv only performs q rotation and addition processes, the number of rotations may be reduced by pᵢ times.

ParMultWgt(U; i₁, i₂, i₃) may be a function that maps a weight tensor U∈ [symbol] ^{f}^{ₕ}^{×f}^{_{w}}^{×e}^{ᵢ}^{×c}^{ₒ} to [symbol] ⁿ^{ₜ}. A parallelly multiplexed shifted weight tensor Ûⁿ⁽ⁱ^{₁}^{,i}^{₂}^{,i}^{₃}⁾=(Ūᵢ_{₅}_{,i}_{₆}_{,i}_{₇}ⁿ⁽ⁱ^{₁}^{,i}^{₂}^{,i}^{₃}⁾)_{0≤i}_{₅}_{<k}_{ᵢ}ₕ_{ᵢ}_{,0≤i}_{₆}_{<k}_{ᵢ}_{w}_{ᵢ}_{,0≤i}_{₇}_{<t}_{ᵢ}ₚ_{ᵢ}∈ [symbol] ^{k}^{ᵢ}^{h}^{ᵢ}^{×k}^{ᵢ}^{w}^{ᵢ}^{×s}^{ᵢ}^{p}^{ᵢ} may be defined as expressed in Equation 6 below, for example, with respect to 0≤i₂<fₕ, 0≤i₂<f_{w}, 0≤iₛ<q.

$${\overline{U}}_{{i}_{5} , {i}_{6} , {i}_{7}}^{″ ( {i}_{1} , {i}_{2} , {i}_{3} )} = \\ \qquad Equation 6$$

$$\{ \begin{matrix}0 , & if {k}_{i}^{2} ( {i}_{7} mod {t}_{i} ) + {k}_{i} ( {i}_{5} mod {k}_{i} ) + {i}_{6} mod {k}_{i} \geq {c}_{i} \\ & or ⌊ {i}_{7} / {i}_{i} ⌋ + {p}_{i} {i}_{3} \geq {c}_{o} \\ & \begin{matrix}or ⌊ {i}_{5} / {k}_{i} ⌋ - ( {f}_{h} - 1 ) / 2 + {i}_{1} ∉ \\ [ 0 , {h}_{i} - 1 ]\end{matrix} \\ & \begin{matrix}or ⌊ {i}_{6} / {k}_{i} ⌋ - ( {f}_{w} - 1 ) / 2 + {i}_{2} ∉ \\ [ 0 , {w}_{i} - 1 ]\end{matrix} , \\ {U}_{\begin{matrix}{i}_{2} , {i}_{2} , {k}_{i}^{2} ( {i}_{5} {modt}_{i} ) + {k}_{i} ( {i}_{5} {modk}_{i} ) + \\ {i}_{5} {modk}_{5} , ⌊ {i}_{7} / {k}_{i} ⌋ + {p}_{5} {i}_{2}\end{matrix}} , & otherwise\end{matrix} ,$$

$$for 0 \leq {i}_{5} < {k}_{i} {h}_{i} , 0 \leq {i}_{6} < {k}_{i} {w}_{i} , and 0 \leq {i}_{7} < {t}_{i} {p}_{i} .$$

ParMultWgt may be defined as ParMultWgt(U; i₁, i₂, i₃)=Vec(Ūⁿ⁽ⁱ^{₁}^{,i}^{₂}^{,i}^{₃}⁾). The multiplexed selecting tensor S′⁽ⁱ⁾ used in the definition of MultConv may be the same as described in FIGS. 5A and 5B.

An algorithm of FIG. 7 may be an example of a MultParConv algorithm for

$${t}_{o} = ⌊ \frac{{c}_{o}}{{k}_{o}^{2}} ⌋ , {p}_{o} = {2}^{⌊ {log}_{2} ( \frac{{n}_{t}}{{k}_{o}^{2} {h}_{o} {w}_{o} {t}_{o}} ) ⌋} .$$

According to various examples, the processor 200 may perform down-sampling or average pooling using packed data.

The processor 200 may obtain the packed data using the packing scheme described with reference to FIGS. 5A to 7. After the down-sampling of the packed data (or a packed tensor) is performed, the processor 200 may separately select and collect only valid data. Here, an output tensor of the down-sampling may also be a packed tensor.

The processor 200 may perform the average pooling by performing rotation and addition on a packed input tensor. The processor 200 may perform index rearrangement to perform a fully connected layer after the average pooling.

The processor 200 may obtain a stride-packed input tensor A′∈ [symbol] × [symbol] × [symbol] for a predetermined interval k. The processor 200 may add all values of [symbol] pieces of data by performing rotation and addition. The processor 200 may perform an operation of dividing by [symbol] by performing a scalar product of the added value and [symbol] . The scalar product may leave only k²t valid inputs, and the rest may be meaningless values.

The processor 200 may obtain an average pooling output with rearranged index by selecting k from among k²t pieces of valid input data and arranging the data on a one-dimensional vector in order.

In order to collect only valid data, the processor 200 may multiply only a position corresponding to the valid data by “1” (or an arbitrary constant that is not “0”), and multiply the remaining position by “0”. Since the scalar product of [symbol] may cause a level to be consumed unnecessarily, the processor 200 may perform an index rearrangement average pooling without consuming an additional level by performing the scalar product of [symbol] only on a valid position and multiplying a meaningless value by “0”.

FIG. 8 illustrates a process of mapping a three-dimensional vector to a one-dimensional vector.

Referring to FIG. 8, a processor (e.g., the processor 200 of FIG. 1) may map a three-dimensional vector 810 onto a one-dimensional vector 830. The processor 200 may map the three-dimensional vector 810 onto the one-dimensional vector 830 using the above-described Vec function.

With respect to a given input tensor, a stride tensor, or a compact stride tensor Ā∈ [symbol] × [symbol] × [symbol] , the Vec function may be defined as expressed in Equation 7 below, for example.

$$\begin{matrix}Vec ( \overline{A} ) = y = ( {y}_{0} , … , {y}_{n - 1} ) ∈ {ℝ}^{n} such that \\ {y}_{i} = \{ \begin{matrix}{\overline{A}}_{⌊ ( i - ⌊ i / {\overline{ℓ}}^{2} ⌋ {ℓ}^{2} ) / \overline{ℓ} ⌋ , i - ⌊ i / \overline{ℓ} ⌋ \overline{ℓ} , ⌊ i / {\overline{ℓ}}^{2} ⌋} , & 0 \leq i < {\overline{ℓ}}^{2} \overline{c} \\ 0 , & otherwise\end{matrix} ,\end{matrix} \qquad Equation 7$$

FIG. 9 illustrates an example of an operation of a homomorphic encryption operation apparatus (e.g., the homomorphic encryption operation apparatus of FIG. 1).

Referring to FIG. 9, a receiver (e.g., the receiver 100 of FIG. 1) may receive an encrypted image for performing a homomorphic encryption operation and a weight for performing an operation with the encrypted image 910.

The processor 200 may generate packed data by performing data packing on the encrypted image 930. The encrypted image may be generated by encoding an input image into a one-dimensional vector and encrypting the encoded one-dimensional vector. A weight may be encoded as a one-dimensional vector.

The processor 200 may perform a rotation operation on the input image or the encrypted image. The processor 200 may multiply data included in the encrypted image by a predetermined constant value. For example, the predetermined constant may be “1”. The processor 200 may generate the packed data by multiplying remaining data among the data included in the encrypted image by “0”.

The processor 200 may determine a mapping constant based on a dimension of a tensor corresponding to the encrypted image. The tensor may be a space of an arbitrary size in which data is stored. The dimension of the tensor may include a height, a width, and a number of channels of the tensor.

The processor 200 may determine the mapping constant based on the number of channels in the tensor corresponding to the encrypted image and a predetermined interval.

The processor 200 may generate the packed data by mapping the data included in the encrypted image to an extended tensor based on the mapping constant.

The processor 200 may determine the mapping constant based on a dimension of a tensor corresponding to the encrypted image. The processor 200 may obtain a mapped tensor by mapping the data included in the encrypted image to the extended tensor based on the mapping constant. The processor 200 may generate the packed data based on a combination of the mapped tensor.

The processor 200 may generate the packed data by determining the mapping constant based on the width, height, or number of channels of the mapped tensor.

The processor 200 may generate copied tensors by copying the mapped tensors a plurality of times. The processor 200 may generate the packed data by arranging the copied tensors in an order.

The processor 200 may perform the homomorphic encryption operation based on the packed data and the weight 950.

The processor 200 may perform a convolution operation based on the packed data and the weight. The processor 200 may perform a rotation operation and addition on a result of the convolution operation. The processor 200 may generate a homomorphic encryption operation result by extracting a valid value from a result of the rotation operation and the addition. The homomorphic encryption operation result may be configured in a form in which a plurality of ciphertexts corresponding to the same plaintext are repeated.

The homomorphic encryption operation apparatuses, receivers, processors, memories, image owners, model owners, operation subjects, homomorphic encryption operation apparatus 10, receiver 100, processor 200, memory 300, image owner 210, model owner 230, operation subject 250, and other apparatuses, units, modules, devices, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. An apparatus, the apparatus comprising:
one or more processors configured to:
generate packed data by performing data packing on an encrypted image; and
perform a homomorphic encryption operation based on the packed data and a weight.

2. The apparatus of claim 1, further comprising a receiver configured to receive the encrypted image and the weight, the encrypted image being for performing the homomorphic encryption operation and the weight being for performing an operation with the encrypted image.

3. The apparatus of claim 1, wherein the encrypted image is generated by encoding an input image into a one-dimensional vector and encrypting the encoded one-dimensional vector.

4. The apparatus of claim 1, wherein the weight is encoded as a one-dimensional vector.

5. The apparatus of claim 1, wherein, for the generating of the packed data, the one or more processors are configured to:
determine a mapping constant based on a dimension of a tensor corresponding to the encrypted image; and
generate the packed data by mapping data comprised in the encrypted image to an extended tensor based on the mapping constant.

6. The apparatus of claim 5, wherein the one or more processors are configured to determine the mapping constant based on a number of channels in the tensor corresponding to the encrypted image and a predetermined interval.

7. The apparatus of claim 1, wherein, for the generating of the packed data, the one or more processors are configured to:
determine a mapping constant based on a dimension of a tensor corresponding to the encrypted image;
obtain a mapped tensor by mapping data comprised in the encrypted image to an extended tensor based on the mapping constant; and
generate the packed data based on a combination of the mapped tensor.

8. The apparatus of claim 7, wherein, for the generating of the packed data based on the combination of the mapped tensor, the one or more processors are configured to:
generate copied tensors by copying the mapped tensor a plurality of times; and
generate the packed data by arranging the copied tensors in an order.

9. The apparatus of claim 1, wherein, for the performing of the homomorphic encryption operation, the one or more processors are configured to:
perform a convolution operation based on the packed data and the weight;
perform a rotation operation and addition on a result of the convolution operation; and
generate a homomorphic encryption operation result by extracting a valid value from a result of the rotation operation and the addition.

10. The apparatus of claim 9, wherein, the generating of the homomorphic encryption operation result, the one or more processors are configured to generate the homomorphic encryption operation result by multiplying the valid value among the result of the rotation operation and the addition by “0” and multiplying a remaining value among the result of the rotation operation and the addition by “1”.

11. The apparatus of claim 9, wherein the homomorphic encryption operation result is configured in a form in which a plurality of ciphertexts corresponding to a same plain text are repeated.

12. A processor-implemented method, the method comprising:
generating packed data by performing data packing on an encrypted image; and
performing a homomorphic encryption operation based on the packed data and a weight.

13. The method of claim 12, further comprising receiving the encrypted image and the weight, the encrypted image being for performing the homomorphic encryption operation and the weight being for performing an operation with the encrypted image.

14. The method of claim 12, wherein the encrypted image is generated by encoding an input image into a one-dimensional vector and encrypting the encoded one-dimensional vector.

15. The method of claim 12, wherein the weight is encoded as a one-dimensional vector.

16. The method of claim 12, wherein the generating of the packed data comprises:
determining a mapping constant based on a dimension of a tensor corresponding to the encrypted image; and
generating the packed data by mapping data comprised in the encrypted image to an extended tensor based on the mapping constant.

17. The method of claim 16, wherein the determining of the mapping constant comprises determining the mapping constant based on a number of channels in the tensor corresponding to the encrypted image and a predetermined interval.

18. The method of claim 12, wherein the generating of the packed data comprises:
determining a mapping constant based on a dimension of a tensor corresponding to the encrypted image;
obtaining a mapped tensor by mapping data comprised in the encrypted image to an extended tensor based on the mapping constant; and
generating the packed data based on a combination of the mapped tensor.

19. The method of claim 18, wherein the generating of the packed data based on the combination of the mapped tensor comprises:
generating copied tensors by copying the mapped tensor a plurality of times; and
generating the packed data by arranging the copied tensors in an order.

20. The method of claim 12, wherein the performing of the homomorphic encryption operation comprises:
performing a convolution operation based on the packed data and the weight;
performing a rotation operation and addition on a result of the convolution operation; and
generating a homomorphic encryption operation result by extracting a valid value from a result of the rotation operation and the addition.

21. The method of claim 20, wherein the generating of the homomorphic encryption operation result comprises generating the homomorphic encryption operation result by multiplying the valid value among the result of the rotation operation and the addition by “0” and multiplying a remaining value among the result of the rotation operation and the addition by “1”.

22. The method of claim 20, wherein the homomorphic encryption operation result is configured in a form in which a plurality of ciphertexts corresponding to a same plain text are repeated.

23. A non-transitory computer-readable storage medium storing instructions that, when executed by one or more processors, configure the one or more processors to perform the method of claim 12.

24. A processor-implemented method, the method comprising:
determining a mapping constant based on a dimension of a tensor corresponding to an image;
generating packed data by mapping data comprised in the image to an extended tensor based on the mapping constant; and
performing a convolution operation based on the packed data and a weight.

25. The method of claim 24, further comprising performing a homomorphic encryption operation comprising the convolution operation, wherein the image is an encrypted image.
